(19) United States
(12) Patent Application Publication
(10) Pub. No.: US 2011/0304597 A1
(43) Pub. Date: Dec. 15, 2011

(54) Low power backlight for display

(75) Inventor: Edward Craig Hyatt, Cupertino, CA (US)

(73) Assignee: Apple Inc., Cupertino, CA (US)

(21) Appl. No.: 12/797,145

(22) Filed: Jun. 9, 2010

(51) Int. Cl. G06F 3/038; G09G 5/10

(52) U.S. Cl. 345/207; 345/690

(57) ABSTRACT

There are provided systems, devices and methods for controlling backlighting in an electronic device. In one embodiment, an electronic device an electronic device having a processor and a display assembly coupled to the processor. The display assembly being configured to provide visual output. The display assembly includes a backlight layer having one or more light sources. At least one of the one or more light sources is coupled to ground via a switch. The switch is configured to selectively operate the one or more light sources to adjust a brightness of the visual output.

### BACKGROUND

I. Technical Field

The present invention relates generally to lighting of electronic devices and, more particularly, to low power backlighting for a display.

II. Background Discussion

Electronic devices such as desktop computers, mobile computing devices, personal digital assistants, cell phones and mobile media devices have become ubiquitous in today's society. They serve as work tools, communication devices and provide entertainment, among other things. In some implementations, graphical displays for the devices are backlit with one or more light sources. The backlighting, however, may produce an uneven illumination of the display. Increasing the number of light sources and distributing them evenly may provide for more even illumination, but at the cost of increased power consumption. Furthermore, the brightness level generated by using multiple light sources may not be suitable for all ambient lighting situations.

### SUMMARY

Certain embodiments may take the form of an electronic device having a processor and a display assembly coupled to the processor. The display assembly may be configured to provide visual output. The display assembly includes a backlight layer having one or more light sources. At least one light source is coupled to ground via a switch. The switch is configured to selectively operate the one or more light sources to adjust a brightness of the visual output.

Another embodiment may take the form of a method of operating a visual display of an electronic device. The method includes providing one or more control signals to selectively operate a plurality of light sources. The method also includes providing a voltage level to the plurality of light sources selected for operation. The voltage level is adjusted to correspond to the voltage demands for operation of the selected light sources.

Yet another embodiment may take the form of an electronic device having one or more ambient light sensors and a processor in communication with the one or more ambient light sensors. The processor is configured to determine a relative brightness of ambient light based on at least one signal from the ambient light sensors. Additionally, the electronic device includes a buck-boost regulator configured to receive a control signal from the processor. The buck-boost regulator adjusts an output voltage based on the control signal. A plurality of light sources are configured to receive the output voltage of the buck-boost regulator and at least one switch is coupled to at least one of the plurality of light sources. The at least one switch is operable by a signal received from the processor to selectively actuate at least one of the plurality of light sources.

### BRIEF DESCRIPTION OF THE DRAWINGS

FIG. 1 is a block diagram illustrating certain components of an electronic device having a display assembly providing for normalized brightness and brightness adjustment.

FIG. 2 illustrates example layers of a backlight layer of the display assembly in the electronic device of FIG. 1.

FIG. 3 is an example schematic diagram of a circuit that provides for selective operation of the light sources.

FIG. 4 illustrates an illumination pattern in a backlight layer when a single light source is used.

FIG. 5 illustrates an opacity pattern corresponding to the illumination pattern of FIG. 4.

FIG. 6 illustrates a foreground display having a normalized brightness resulting from the opacity pattern of FIG. 5.

FIG. 7 illustrates an illumination pattern in a backlight layer when two light sources are used and positioned in opposite corners.

FIG. 8 illustrates an opacity pattern corresponding to the illumination pattern of FIG. 7.

FIG. 9 illustrates a foreground display having a normalized brightness resulting from the opacity pattern of FIG. 8.

FIG. 10 illustrates an illumination pattern in a backlight layer when four light sources located in different corners are used.

FIG. 11 illustrates an opacity pattern corresponding to the illumination pattern of FIG. 10.

FIG. 12 illustrates a foreground display having a normalized brightness resulting from the opacity pattern of FIG. 11.

FIG. 13 is a flowchart illustrating a technique for controlling the brightness of a display of the electronic device of FIG. 1.

FIG. 14 illustrates a schematic diagram of light sources in a serial-parallel arrangement with switches to selectively operate the light sources.

### DETAILED DESCRIPTION

Generally, certain embodiments may take the form of a backlight assembly for an electronic graphical display. The backlight assembly may enhance or facilitate even lighting across the display while providing relatively low power consumption. In particular, the backlight assembly may include a buck-boost regulator for powering light sources such as light emitting diodes (LEDs). Generally, the buck-boost regulator may be configured to adjust an input voltage level (VIN) to an output voltage level (VOUT) suitable for operating one or more light sources. The buck-boost regulator may adjust VIN based on an adjust signal. Additionally, a pulse width modulation (PWM) signal may be used to fine-tune VOUT. That is, the buck-boost regulator may be configured to receive a PWM signal with an adjustable duty cycle for the operation of VOUT to allow for fine adjustments with respect to the amount of light output by the light sources.

Hence, the backlight assembly may provide improved power efficiency by limiting the power consumption of the backlighting. In particular, power may be saved by reducing the amount of voltage produced by the buck-boost regulator. As voltage is decreased, the regulator typically becomes more efficient.

Additionally, in some embodiments the backlight assembly includes a switching circuit that selects one or more light sources for operation. The light sources may be arranged in a serial, parallel, or serial-parallel configuration. One or more of the light sources may be coupled to one or more switches. The switches may selectively control the operation of the light sources. Specifically, the switches may control whether an associated light source is on or off.

Further, a display assembly may be provided that includes a backlight assembly and display device. The display device may include a control layer (implemented in software and/or hardware) that may be configured to control the amount of light that passes therethrough from the light sources to be seen by a user. As the brightness of light from the backlight may not be distributed evenly across the display, the control layer may be configured to provide the appearance of even brightness. In some embodiments, the control layer may take the form of an alpha channel, sometimes referred to as an alpha layer. The alpha layer may be a graphical layer that sets a transparency of an image provided on the display. Generally, the alpha layer may be a negative of the backlight pattern to even distribute brightness of a displayed image. The control layer may be implemented as a physical layer in the backlight assembly in certain embodiments, while in other embodiments the control layer may be created through software routines that adjust the intensity and/or brightness of the pixels in a display.

That is, in some embodiments, the control layer may be implemented as a software layer by a component that outputs a displayed image. For example, the displayed image may be provided as one or more layers, such as a foreground layer, rendered by a liquid crystal display (LCD) and the alpha layer may be graphically rendered as another virtual image layer by the LCD display. In other embodiments, the control layer may be provided by a physically separate layer. For example, the alpha layer may be provided by a first display device and other graphical images by a second display device. In such embodiments, the first display device is generally transparent when the alpha layer is not active. For example, the first display device may be formed from an organic light emitting diode (OLED) matrix or layer. In some embodiments, the control layer may be provided as a binary transparent layer that can be added or taken away depending on the backlighting provided by the light sources.

In still other embodiments, one or more light sensors may implemented. In some embodiments, the light sensors may be used to determine an ambient light level. The ambient light level may be used to adjust the backlighting of the device to a suitable level. In some embodiments, the one or more light sensors may be provided for determining the brightness of a display and, more particularly, the distribution of brightness across the display. The information from the light sensors may be provided in a feedback loop to aid in controlling the operation of the light sources (e.g., how many light sources should be used) and/or the control layer (e.g., determining a pattern for the control layer).

One or more specific embodiments are described in greater detail below with reference to the drawings and in the context of an electronic device. However, the disclosed embodiments should not be interpreted or otherwise used as limiting the scope of the disclosure, including the claims. In addition, one skilled in the art will understand that the following description has broad application and the discussion of any particular embodiment is meant only to be exemplary and is not intended to suggest that the scope of the disclosure, including the claims, is limited to these embodiments.

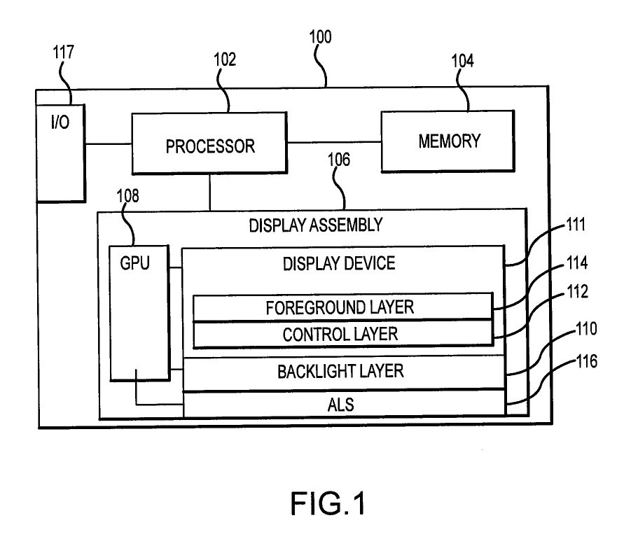

FIG. 1 illustrates a simplified block diagram of certain components of an electronic device 10, including a backlit display. The electronic device 100 may include, among other things, a processor 102, a memory 104, and a display assembly 106. Generally, the processor 102 may be any suitable microprocessor and may include one or more processing cores. For example, in some embodiments, the processor 102 may be an Apple® A4 processor or an Intel® Core™ 2 Duo processor, and may be configured to process data and execute applications and programs. The processor 102 may be configured to operate one or more operating systems, such as IPhone® OS 3.0® or Mac OS X from Apple®, or Microsoft® Windows® 7, for example, and applications compatibly operable within the operating systems.

The processor 102 may be communicatively coupled to other component parts of the electronic device 100. Specifically, the processor 102 may be coupled to the memory 104 and the display assembly 106. The memory 104 may include one or more conventionally implemented memory and/or storage technologies, such as random access memory, flash memory, and so forth. The memory 104 may store the operating system, applications, programs, and so forth.

The display assembly 106 may also be coupled to the processor 102 which, in turn, may control the operation of the display assembly. In some embodiments, the display assembly 106 may include or take the form of a dedicated processor, such as a graphical processing unit (GPU) 108 for processing data for display and/or generally controlling the operations of the display assembly. The display assembly 106 may include multiple hardware layers configured to provide a visual output. In particular, the display assembly 106 may include a backlight layer 110 that provides the backlighting for the display assembly.

Additionally, the display assembly 106 may include display device 111 configured to provide a graphical display for viewing by a user. For example, the display device 111 may include one or more LCDs, one or more LED displays, one or more OLED displays, and so forth, or a combination of two or more display technologies.

In some embodiments, the display device 111 may be considered to include multiple layers, for example a control layer 112 and a foreground layer 114, that are rendered in software. In some embodiments, the control layer 112 and the foreground layer 114 may be implemented in a single display device (e.g., in a single LCD display device). In other embodiments, the control layer 112 may be implemented in a first hardware layer (e.g., a first LCD) and the foreground layer 114 may be implemented in a second hardware layer (e.g., a second LCD).

Generally, the control layer 112 may be implemented as an alpha layer controlling the opacity of the display to aid in providing a uniform backlighting appearance. That is, the control layer 112 may control the transparency of the display and thus adjust or compensate for the amount of light produced by the backlight and viewable by a user. In some embodiments, the transparency may be controlled by activating pixels to block or reduce backlighting. The pixels may be activated in accordance with a particular pattern based on the pattern of backlighting. In particular, the pattern of activated pixels may be an inverse of the lighting pattern of the backlights. As such, the activated pixels would be darkest over areas where the backlight is brightest and pixels may not be activated over areas where the backlight is dimmest.

Additionally, in some embodiments, the control layer 112 may be dynamic so that it may change in accordance with changing backlighting patterns. It should be noted that the pixels themselves are not necessarily only dark or light, but can be various shades therebetween. Further, when pixels are “activated” to implement the alpha layer, they may be grayscaled and implemented as a software layer overlaid on an image to color shift portions of that image. That is, if part of the alpha layer is to be dark, the image “beneath” that portion of the alpha layer would have a darker hue or tint, or optionally be dimmer (e.g., less bright), than the image would appear without the alpha layer.

In some embodiments, the alpha layer may be implemented as integral with other layers. For example, in some embodiments, the foreground layer 114 may be generated to include the effects of the alpha layer. That is, a displayed image may be processed to emulate the effects of the alpha layer.

The foreground layer 114 may be provided as one or more graphical layers configured to provide a graphical output to a user. As such, the foreground layer 114 may provide letters, symbols, words, images, and so forth, as output. In some embodiments, such as in the case of text based output, the foreground layer 114 may include a single layer. It should be appreciated that the foreground layer 114 may be behind the alpha layer despite its name.

Light sensors, such as ambient light sensors 116, may also be provided as part of the display assembly 106 or in association with the display assembly. The ambient light sensors 116 may be provided to sense a level of ambient light in which the display is operating. Additionally or alternatively, the ambient light sensors 116 may be configured to sense the brightness of the display and/or a brightness pattern of the display. The ambient light sensors 116 may be coupled to a processor, such as the GPU 108, and the processor may operate and/or adjust the operation of one or more layers of the display assembly based, at least in part, on data received from the sensor(s). In particular, the number and/or brightness of light sources within the backlight assembly may be adjusted, as will be discussed in greater detail below. Additionally, or alternatively, the control layer 112 may be controlled to provide a desired display output. For example, the control layer 112 may modify a pattern for allowing a uniform lighting to be displayed and/or to increase or decrease the brightness of the display.

Additionally, the device 100 may include one or more I/O devices 117 for receiving input from and providing output to users. In particular, in some embodiments, an input device, such as one or more buttons, may be provided to allow a user to adjust brightness of a display. User adjustment of the display brightness is discussed in greater detail below.

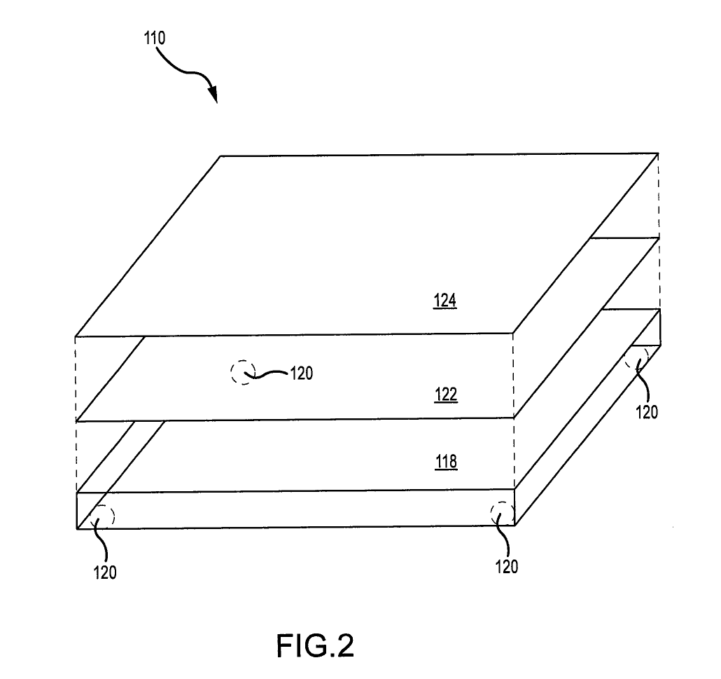

FIG. 2 illustrates the backlight layer 110 in accordance with an example embodiment. The backlight layer 110 may include one or more reflective surfaces 118 configured to direct light out of the display assembly 106. In some embodiments, the reflective surfaces 118 may be configured as an open top box; such a box may have five reflects sides and be open in a direction toward the other layers of the display assembly. In addition to the reflective surfaces 118, there may be one or more other layers. For example, in some embodiments a filter/polarizer 122 may be provided. Additionally, in some embodiments a diffuser 124 may be provided.

One or more light sources may be located within the reflective layer 118 or otherwise configured to emit light into the reflective layer. For example, in some embodiments, one or more light emitting diodes (LEDs) 120 may be used. It should be appreciated that in other embodiments, other types of light sources, such as cold cathode fluorescent lamps, incandescent lights, and so forth, may be implemented. Additionally, it should be appreciated that, although four LEDs 120 are illustrated in FIG. 2, there may be more or fewer light sources included in an actual implementation to achieve a desired level of backlighting.

The light sources may be powered through any suitable power supply and, in some embodiments, may be configured to operate independently of one another. That is, one or more of the LEDs 120 may be configured to turn on regardless of the state of the other LEDs.

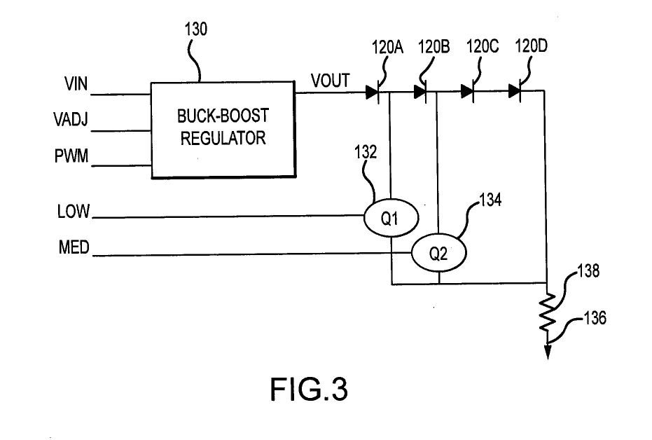

FIG. 3 illustrates an example schematic diagram for powering and selectively operating the LEDs 120. As shown, the LEDs 120 may be serially coupled and powered by a voltage regulator, such as a buck-boost regulator 130. In other embodiments, other types of regulators may be implemented to achieve a desired result. For example, a boost regulator may be implemented in embodiments where a battery voltage level is suitable for the operation of one light source and may be increased to accommodate more than one light source.

The buck-boost regulator 130 may be configured to step-up (e.g., boost) an input voltage VIN or step-down (e.g., buck) the input voltage VIN to provide a desired voltage level to the LEDs 120. For example, in some embodiments, the input voltage VIN may be 3.6V, provided directly from a battery (not shown) of the electronic device 100. As each LED 120 requires approximately 1.7V to 3.8V to operate, depending on the color and specifications for the particular LED, the buck-boost regulator 130 may be configured to supply approximately 1.7V to approximately 15.2V to operate anywhere from a single LED 120 to all four LEDs 120. In other embodiments, the buck-boost regulator 130 may be configured to provide even higher voltage levels depending, at least in part, on the number of LEDs present in the backlight layer 110.

The LEDs 120 may be selectively operated through coupled switches, transistors, or the like. For example, a first switch 132 may be coupled between a cathode 121 of a first LED 120A and ground 136 and a second switch 134 may be coupled between a cathode 123 of a second LED 1208 and ground 136, while the cathode 125 of the third LED 120C is coupled to the fourth LED 120D and the cathode 127 of the fourth LED is coupled to ground. In this configuration, actuation of the first switch directs all current thought the first LED 120A, actuation of the second switch 134 directs current through both the first and second LEDs, and when neither switch is activated current flows through each of the LEDs 120A, 1208, 120C, 120D. Generally, “actuation” of a switch as used herein refers to closing the switch so that current may flow therethrough. Additionally, in some embodiments, the actuation of a switch is exclusive of other switches. For example, if switch 132 is actuated, switch 134 is not actuated. Table 1 indicates the operative states of the LEDs and the corresponding states of the switches in accordance with an embodiment. The actuation of both switches 132, 134 simultaneously is not allowed in this embodiment, although in other embodiments having different configurations more than one switch may be actuated at one time.

TABLE 1

| 2^{nd} Switch | 1^{st} Switch | LED | LED | LED | LED |
|---|---|---|---|---|---|
| 134 | 132 | 120A | 120B | 120C | 120D |
| Open | Open | On | On | On | On |
| Open | Closed | On | Off | Off | Off |
| Closed | Open | On | On | Off | Off |

| | | |
|---|---|---|
| Closed | Closed | Not Allowed |

The actuation of switches couples the LEDs directly to ground 136. Specifically, actuation of the first switch 132 couples LED 120A directly to ground, thus shunting current (i.e., current does not flow through LEDs 1206, 120C, 120D. Resistive elements, such as a resistor 138, are provided between the LEDs 120 and ground 136 to help reduce the amount of current that flows through the LEDs. The size of the resistor may depend upon the amount of current desired to flow through the diodes. The amount of current flow will to some degree influence how bright the LEDs 120 operate.

In some embodiments, the switches 132, 134 may be transistors, such as metallic-oxide semiconductor field effect transistors (MOSFETs). In other embodiments, the switches 132, 134 may be mechanical switches that are electrically actuated, such as micro-electromechanical (MEM) switches, or the like. The switches 132, 134 may be actuated via signal received from a processor or other suitable element. For example, a LOW signal may actuate the first switch 132 so that first LED 120A is actuated without actuating the other LEDS 120. Thus, the LOW signal provides a relatively low backlight intensity, as only a single LED is lit. A MED signal may actuate the second switch 134 so that both the first LED 120A and second LED 1208 are actuated, providing a higher intensity backlight. When neither of the first and second switches 132, 134 are activated, all of the LEDs 120 emit light, resulting in a bright backlight.

When one of the switches 132, 134 are actuated, the number of LEDs 120 in use is reduced and therefore less voltage may be used to drive the LEDs of the backlight layer 110. As such, the buck-boost regulator 130 may be configured to adjust the output voltage VOUT corresponding to the number of LEDs in use at a particular time. An adjustment signal (labeled “VADJ” in FIG. 3) may be provided to the buck-boost regulator 130 for the purpose of gross adjustment. The VADJ signal indicates either an increase or a decrease of the VIN signal to achieve a desired VOUT signal based on the number of LEDs 120 in operation. In some embodiments, the VADJ signal may be provided from a processor. In particular, the processor may generate the VADJ signal to vary the output voltage level of the buck-boost regulator to closely match the number of active light sources. VADJ may be, for example, a low-current variable reference voltage from a processor-controlled digital-to-analog converter or may be a variable resistance from a processor controlled digital potentiometer. VADJ determines the target VOUT that the buck-boost regulator attempts to maintain over a range of input voltages and varying loads on VOUT.

Improved power efficiency for the device 100 is achieved by reducing the boost level of the regulator 130 when fewer light sources are powered. Additionally, power efficiency may be improved by matching the regulator output VOUT with the driven load (e.g., light sources). For example, when fewer than all the LEDs are to be operated, the voltage level may be decreased (i.e., the step-up ratio may be decreased) and correspondingly less power may be lost to heat and other parasitic effects due to the lower voltage.

In addition to gross adjustment that may be provided by the VADJ signal, fine adjustment may be achieved by a pulse width modulated (PWM) signal. In some embodiments, the PWM signal may be provided from the processor. In some embodiments, the PWM signal may fine tune the voltage level of the VOUT signal of the buck-boost regulator 130 based on the PWM signal's duty cycle. For example, when the PWM signal has a duty cycle greater than 50%, the buck-boost regulator 130 boosts the incoming voltage VIN level. When the PWM signal has a duty cycle less than 50%, the buck-boost regulator 130 bucks (e.g., decreases) the incoming voltage level. As such, to increase or decrease VOUT, the duty cycle of the PWM signal may be modified.

As the PWM signal may control voltage level of the VOUT, it also may be used to control the brightness of the backlighting in some embodiments. Generally, the brightness of the an LED depends upon the amount of current flow therethough, as VOUT increases the voltage across the LED increase and so does the current (assuming other variables remain constant). Thus, the PWM signal may control the brightness of the LEDs through increasing or decreasing the voltage level supplied.

Alternatively, in some embodiments, the PWM signal may be used to control the VOUT on and off times to control brightness. In particular, VOUT may be on during a high portion of the PWM duty cycle and off during a low portion of the PWM signal duty cycle. Thus, during a high portion of the duty cycle the LEDs are illuminated and during a low portion of the duty cycle the LEDs are off (as VOUT is off). In order to increase the brightness, the duty cycle is increased so that VOUT is on more of the time than it is off. That is, assuming that a duty cycle is initially at 50%, increasing the duty cycle to greater than 50% increases the brightness while decreasing the duty cycle to less than 50% dims the lighting. In embodiments where the duty cycle of the PWM signal controls when VOUT is on/off, the PWM signal operates at a frequency that renders the turning on and off of the LEDs 120 imperceptible to a user (e.g., greater than 85 Hz). In particular, the frequency of the PWM signal is sufficiently high as to be imperceptible. A user of the device 100 will see either a brighter or dimmer display without perceiving the LEDs 120 turning on and off.

In some embodiments, the duty cycle of the PWM signal, and therefore the brightness of the backlight, may be controlled by the user to achieve a desired backlight brightness. In particular, the device 100 may include a hardware and/or software interface whereby the brightness may be adjusted by the user by adjusting the duty cycle of the PWM signal. For example, an up-down cantilever switch may be provided to adjust the brightness up or down base on user input via the switch.

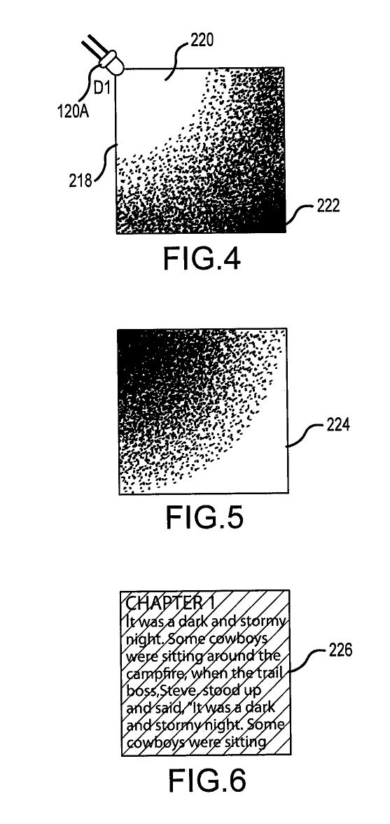

FIGS. 4-6 illustrate an example illumination pattern, opacity pattern, and foreground display, respectively for operation of a single light source. In particular, FIG. 4 illustrates an illumination pattern 218 in the backlight layer 110 when the first LED 120A is illuminated alone. As shown, the backlight layer 110 is brightest in a corner 220 where the LED 120A is located and darkest in an opposite corner 222. The opacity pattern functions to block light from the backlight layer 110 from being viewed by a user viewing the foreground display. As such, the opacity pattern is a pattern of opaqueness that is the negative of the illumination pattern and serves to normalize the light that illuminates the foreground display. That is, the opacity pattern serves to normalize the backlighting of the foreground display.

In FIG. 5, an opacity pattern 224 is illustrated. As mentioned above, the opacity pattern 224 may be thought of as a negative or inverse of the backlight illumination pattern 218 and, in some embodiments, may be an alpha layer. Where the backlight layer illumination pattern 218 is brightest, the alpha layer opacity pattern 224 is darkest and vice-versa. The alpha layer opacity pattern 224 is transparent and normalizes the brightness provided by the backlight across the display. FIG. 6 illustrates a foreground layer 226 having text with a normalized brightness that is constant across the display.

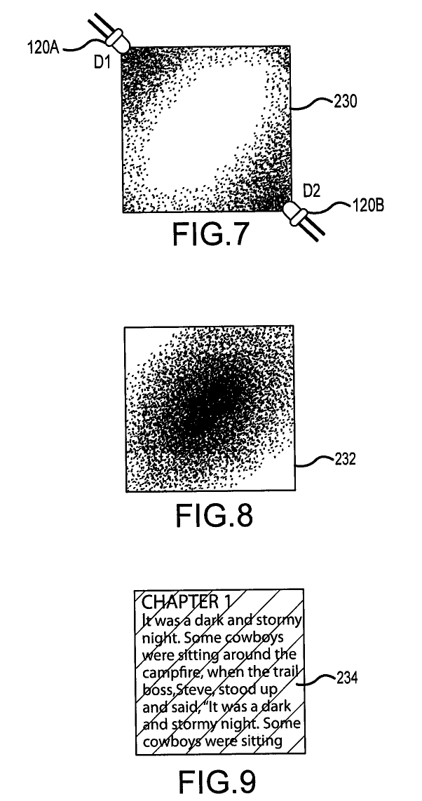

FIGS. 7-9 illustrate an example illumination pattern, opacity pattern, and foreground display, respectively, for operation of two light sources. In particular, FIG. 7 illustrates the illumination pattern 230 provided when LEDs 120A, 120B are illuminated at opposite corners and FIG. 8 illustrates a corresponding opacity pattern 232 generated in the alpha layer. Because the LEDs 120A, 120B are directing light towards a center of the backlight layer, the illumination pattern 230 may be brightest in the center. Conversely, the opacity pattern 232 is darkest in the center to prevent the center from being brighter than the rest of the display. FIG. 9 illustrates a textual foreground layer 234 resulting from the normalization provided by the opacity pattern 232 in the alpha layer. Comparison of the foreground layer 234 with the foreground layer 226 reveals that the foreground layer 234 resulting from the operation of two LEDs is brighter. The cross-hatching indicates a relative brightness/dimness of the display. Specifically, a tighter cross-hatching indicates a dimmer display.

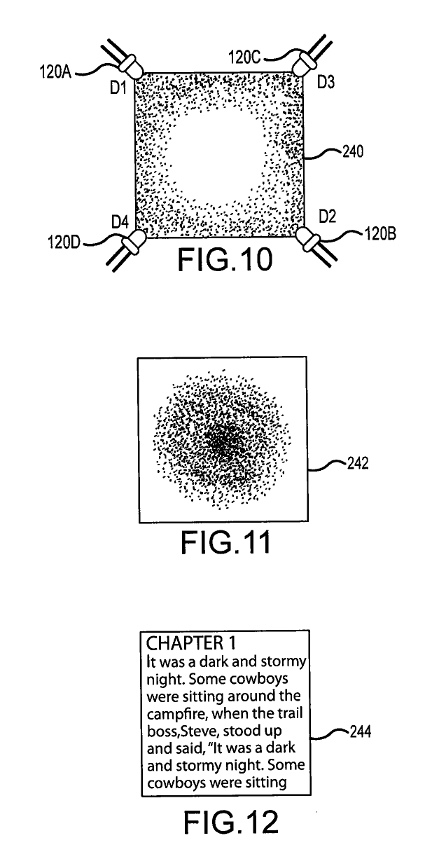

FIGS. 10-12 illustrate an example illumination pattern, opacity pattern, and foreground display, respectively, for operation of four light sources. Specifically, FIG. 10 illustrates the illumination pattern 240 of background layer 110 when the four LEDs 120A, 120B, 120C, 120D are illuminated, each from its own corner. As light is directed toward the center from each of the LEDs 120A, 120B, 120C, 120D, the center is a bright spot. In contrast, an opacity pattern 242 generated as an alpha layer is darkest in the center to aid in normalization of the brightness of the display. FIG. 12 illustrates the foreground display 244 with the backlighting being normalized by the opacity pattern. The foreground display 244 is brighter (i.e., no cross-hatching) than that of the previous two foreground displays 226, 234 because more light sources were used. As discussed above, however, in some embodiments, a user may be provided with the ability to control a PWM signal to make fine adjustments to the brightness of the display in accordance with the user's preference.

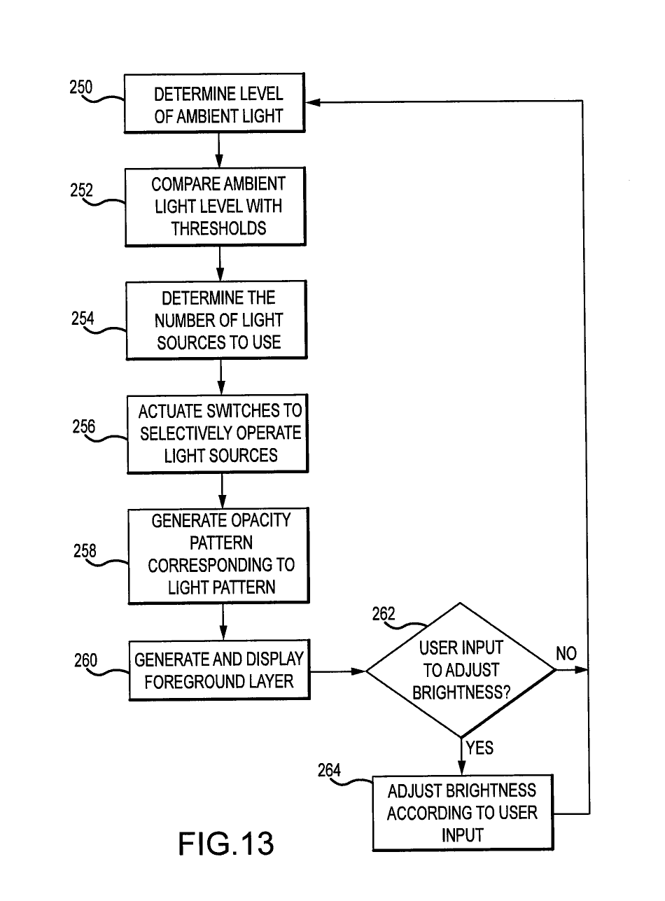

In some embodiments, the determination as to the number of light sources to be used may be automated. For example, the ambient light sources 116 may be deployed to determine the brightness of an operating environment. In brighter environments, a brighter display may be beneficial and, hence, more light sources may be used. Similarly, in a darker environment, fewer light sources may be used, as the contrast will be more stark. FIG. 13 is a flowchart illustrating operation of the display assembly in conjunction with the ALS 116.

An ambient light level may be determined using the ALS 116 (Block 250). The ambient light level may be compared with one or more thresholds (Block 252). The one or more thresholds may be determined empirically as being baselines for when a certain number of light sources should be used. For example, a first threshold may correspond to artificially lit room at night and a second threshold may correspond to a sunny day outside. Thus, one threshold may correspond relatively dark operating environment while the other corresponds to a relatively bright operating environment. The threshold corresponding to dark environment may be used to determine when a single light source may be used and the threshold corresponding to the bright environment may be used to determine when all or many of the light sources may be used. The region between the two thresholds may be used when some number of light sources greater than one and less than all may be used.

From the comparison with the thresholds, it is determined how many light sources will be used (Block 254). Switches may then be actuated (or not) to operate the desired number of light sources (Block 256). The control layer then generates a corresponding opacity pattern (Block 258). The opacity pattern is a negative of the brightness pattern generated by the light sources. As the number and various possible configurations of the light sources may be known, the opacity patterns may be stored in the memory 104 of the device 110 and retrieved for use as appropriate. That is, for example, the opacity patterns corresponding to when one, two, or four light sources are used may be stored in memory and retrieved when a corresponding number of light sources is used.

The foreground layer(s) are then generated and displayed (Block 260). Additionally, user input may be polled to determine if user input has been received related to the brightness of the display (Block 262). If user input has been received, the brightness may be finely adjusted (Block 264). In particular, in some embodiments, a duty cycle of the PWM signal may be adjusted based on user input. The ALS 116 may continually or periodically determine the brightness of the operating environment and autonomously make adjustments to the brightness level of the display.

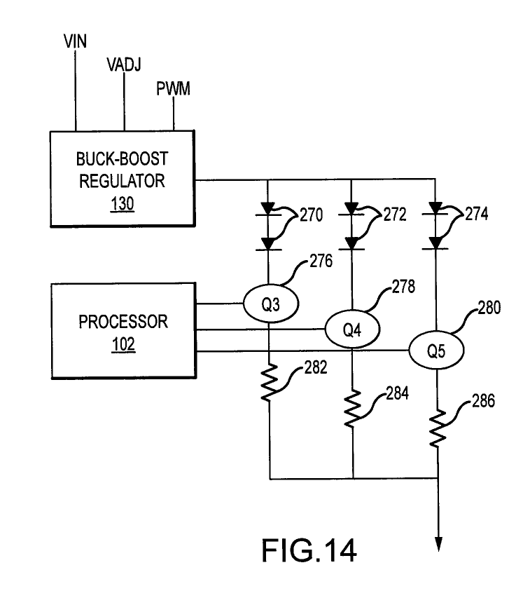

It should be appreciated that, although the foregoing examples have included four LEDs 120, other embodiments may include more or fewer light sources. Additionally, while the LEDs 120 are shown as being serial coupled, they may be coupled in parallel or serial-parallel configurations as well. For example, FIG. 14 illustrates LEDs 270, 272, 274 in a serial-parallel configuration. Each set of serial coupled LED set is coupled to a switch 276, 278, 280, and a resistor 282, 284, 286. In order to actuate a set of serial coupled LEDs, the corresponding switch is actuated. For example, in order to actuate LEDs 270 and 272, switches 276 and 278 are actuated. Each switch 276, 278, 280 may be controlled by the a processor, such as processor 102. Additionally, the buck-boost regulator 130 may be provided with the VADJ and PWM signals to allow for adjustment of the VIN signal to provide a suitable output to drive the LEDs 270, 272, 274.

Although various specific embodiments have been described above, it should be appreciated that a single device may implement various different aspects of the specific embodiments described above. Further, one or more aspect may be implemented in an embodiment without including other aspects.

1. An electronic device comprising:
a processor;
a display assembly coupled to the processor configured to provide a visual output, the display assembly comprising:
a display layer;
a backlight layer positioned behind the display layer comprising one or more light sources, wherein at least one of the one or more light sources is coupled to ground via a switch, the switch being configured to selectively operate the one or more light sources to adjust a brightness of the visual output; and
a control layer positioned in front of the backlight layer, the control layer configured to generate an opacity pattern based at least in part upon the operation of the one or more light sources, wherein the opacity pattern normalizes the brightness of the visual output.

2. The electronic device of claim 1 wherein the control layer is configured to generate the opacity pattern as a negative of a lighting pattern generated by the one or more light sources.

3. The electronic device of claim 1 wherein the display assembly further comprises a voltage regulator configured to increase or decrease a voltage level to correspond with the number of one or more light sources selected for operation.

4. The electronic device of claim 3 wherein adjustment of the voltage level is in accordance with a voltage adjustment signal received by the voltage regulator from the processor.

5. The electronic device of claim 3 wherein the brightness of the visual output is user adjustable.

6. The electronic device of claim 3 wherein a duty cycle of a pulse width modulated signal provided to the voltage regulator is adjusted to adjust the brightness of the visual output.

7. The electronic device of claim 1 wherein the at least one switch comprises a transistor.

8. The electronic device of claim 1 wherein the at least one switch comprises a mechanical switch.

9. The electronic device of claim 1 wherein the control layer comprises a graphical alpha layer configured to generate a pattern negative to an illumination pattern generated by operation of the one or more light sources.

10. The electronic device of claim 1 wherein the control layer comprises a hardware layer.

11. The electronic device of claim 1 wherein the one or more light sources comprise one or more light emitting diodes.

12. The electronic device of claim 11 wherein the one or more light emitting diodes are electrically coupled in series.

13. The electronic device of claim 11 wherein the one or more light emitting diodes are electrically coupled in parallel.

14. A method of operating a visual display of an electronic device comprising:
selecting a number of a plurality of light sources for operation to provide a desired backlight;
providing one or more control signals to selectively operate the number of light sources, thereby backlighting the visual display; and
providing an output voltage signal to the number of light sources selected for operation; and
setting an output voltage level of the output voltage signal based on a voltage demand of the selected light sources.

15. The method of claim 14 further comprising selectively operating the number of light sources by actuation of one or more switches coupled between one or more of the number of light sources and a ground plane, the control signals opening and closing the one or more switches to actuate one or more of the number of light sources.

16. The method of claim 15 further comprising:
using one or more light sensors to determine a light level of an operating environment;
comparing the determined light level to one or more thresholds to determine a suitable light output based on the light level of the operating environment; and
adjusting a number of the one or more light sources selected for operation based on the results of the comparison to achieve the suitable light output.

17. The method of claim 16 wherein the one or more light sources selected for operation generate a light pattern, wherein the method further comprises generating an opacity pattern in a graphics layer.

18. The method of claim 17 further comprising generating a graphical foreground layer, wherein the brightness of the backlighting for the graphical foreground layer is normalized by the opacity pattern.

19. The method of claim 18 further comprising adjusting the brightness of the backlighting by adjusting a duty cycle of a pulse width modulated signal.

20. An electronic device comprising:
one or more ambient light sensors;
a processor in communication with the one or more ambient light sensors, the processor configured to determine a relative brightness of ambient light;
a buck-boost regulator configured to receive a control signal from the processor, the buck-boost regulator adjusting an output voltage based on the control signal;
a plurality of light sources configured to receive the output voltage of the buck-boost regulator; and
at least one switch coupled to at least one of the plurality of light sources, the at least one switch operable by the processor to selectively actuate at least one of the plurality of light sources.
